(19) United States
(12) Patent Application Publication
(10) Pub. No.: US 2026/0353037 A1
(43) Pub. Date: Nov. 5, 2026

(54) MULTI-ACCESS EDGE COMPUTING (MEC) SERVICES IN A CELLULAR NETWORK

(71) Applicants: Vodafone Group Services Limited, Newbury, Berkshire (GB); Vodafone Automotive S.p.A., Varese (IT)

(72) Inventors: Guido GEHLEN, London (GB); Jean-Luc DESCOMBES, Grasse (FR)

(21) Appl. No.: 19/489,068

(22) PCT Filed: May 29, 2024
(86) PCT No.: PCT/EP2024/064828

§ 371 Date: Dec. 1, 2025

(30) Foreign Application Priority Data
Jun. 1, 2023 (IT) 102023000011283

(51) Int. Cl. H04W 4/029; H04L 67/52; H04L 67/55; H04W 4/021

(52) U.S. Cl. CPC H04W 4/029; H04L 67/52; H04L 67/55; H04W 4/021

(57) ABSTRACT

A method for provisioning one or more Multi-access Edge Computing (MEC) services to a client device in a cellular network includes retrieving, by a client device, a list of service areas, each service area representing a geographical area, wherein a server is associated with each service area, the server associated with each service area being configured to provide the one or more MEC services to one or more client devices, determining a geographical location of the client device, identifying a service area relevant to the client device by comparison of the geographical location of the client device with the list of service areas, and facilitating, a communication session between the client device and the server associated with the identified service area, the communication session for provisioning the one or more MEC services to the client device by the server associated with the identified service area.

### FIELD OF THE INVENTION

A method, a client device and a system for providing Multi-access Edge Computing (MEC) services to a client device in a cellular network. A communication session is established between the client device and a server associated with a Service Area relevant to the geographical location of the client device, in order to provide the one or more MEC services to the client device. One of the MEC services provided to a client device is a message broker to manage publications and subscriptions according to a publish/subscribe protocol.

### BACKGROUND TO THE INVENTION

Multi-access edge computing (MEC) is a network architecture that enables distributed computing capability at the edges of a cellular network, rather than at the network core. MEC enables provision of services and network functions, including running of applications and performing other processing tasks. MEC services may be provided by MEC application servers embedded at a radio access network (RAN) element of the cellular network. Beneficially, this allows the provision of services physically closer to the client device of an end user, shortening the pathway for data transmission and thereby reducing latency and network congestion. MEC also allows cellular operators to open their radio access network (RAN) to authorized third parties, such as application developers and content providers, thus lowering barriers for use of specific applications on different cellular networks, and to increase the variety of services available to users.

Due to the distributed network architecture of MEC, the particular MEC application server providing services to a specific client device will depend on the geographical location of the client device. Moreover, different MEC servers may provide a different group of services, and so the services available to a client device will also change depending on the MEC application server to which the client device is connected. To obtain maximum benefit from the MEC network architecture, the client device must connect to a specific MEC application server. Identification of the optimal MEC application server to which a client device should connect, especially when the client device is moving through regions and over borders between geographical areas served by different MEC applications servers, is a complex problem. Furthermore, continuity of service during handover also poses challenges.

In some prior art systems (such as described in US Patent Publication US 2019/373516), signal characteristics are evaluated in order to determine when services to a client device should be handed over from a first server to a second server. In systems such as those described in UK Patent Publication GB 2547426, an X2 interface is established between a first and a second server, in order to share data relating to a communication session between a client device and a given server and to provide continuity of a communication session upon handover.

There is a desire for an improved system and method providing one or more Multi-access Edge Computing (MEC) services to a client device in a cellular network.

### SUMMARY OF THE INVENTION

There is described a method for providing MEC services to a client device. The client device may retrieve a list of service areas, identify an appropriate or relevant service area to which to connect based on the geographical location of the client device, and then establish or continue to support and maintain a communication session with a server at the identified appropriate or relevant service area. In some cases where a client device is close to a border between two service areas, the client device may identify more than one relevant service area based on the geographical location of the client device, and then establish or continue to support and maintain communication sessions with a server at each of the identified relevant service areas. During a communication session, the application server can provide services to a client device. One possible service is provision of a message broker at the server in order to manage subscription and publication of messages under a publish/subscribe protocol. In this way, information can be provided to a client device that is relevant to its geographical location.

In a first aspect there is a method for provision of one or more Multi-access Edge Computing (MEC) services to a client device in a cellular network comprising:
retrieving, by a client device, a list of service areas, each service area representing a geographical area, wherein a server is associated with each service area, the server associated with each service area being configured to provide the one or more MEC services to one or more client devices;
determining, by the client device, a geographical location of the client device;
identifying, by the client device, a service area relevant to the client device by comparison of the geographical location of the client device with the list of service areas;
facilitating, by the client device, a communication session between the client device and the server associated with the identified service area, the communication session for provision of the one or more MEC services to the client device by the server associated with the identified service area.

MEC services may be provided via an application server associated with or at a given service area. Various services can be provided by the MEC application server, including but not limited to a message broker for use in a publish/subscribe protocol, eGaming (especially outdoor/real-time multiplayer games), eHealth, logistics, control of a connected drone, or control or set-up of autonomous operating robots. The server may be an application server located within the service area or located outside the service area but otherwise allocated or linked to the service area.

In some cases, the service areas may be defined in terms of one or a series of geohash areas. Alternatively, the service areas may be denoted by boundaries defined in terms of coordinates. The service areas may be defined having any appropriate shape, for instance each service area may represent a polygonal geographical area. The list of service areas may be a list or database linking a geographical area or region with a particular service area. Typically, each geographical location will be associated with one service area.

The geographical location of the client device may be determined either as a geohash location, or as coordinates, or according to any other reasonable means. The service area relevant to the client device may be identified by comparison of the geographical location of the client device with a list or database of service areas (in other words, look up from a predetermined table).

Facilitating a communication session may comprise establishing a new communication session or maintaining an existing communication session. In particular, facilitating a communication session may comprise linking or connecting (or maintaining a link or connection) between a client device and a server associated with a particular service area.

Advantageously, the method provides a straightforward and efficient approach for identifying a suitable and optimal service area to which a client device should connect.

One of the one or more MEC services may be a message broker to manage publications and subscriptions according to a publish/subscribe protocol, wherein each server associated with a respective service area is configured to host a message broker. In other words, each service area has an associated server, and each server may host a message broker to manage publications and subscriptions and to route publications within the service area. For instance, the message broker may receive subscription requests from a client device to receive publications related to a certain topic. The message broker may further manage publishing of a received publication related to a certain topic, so as to publish said publication to client devices subscribed to the said topic. The message broker may further manage unsubscription requests. The publish/subscribe protocol offers an efficient and targeted method of sending information to a subsection of client devices within a service area. The publish/subscribe protocol may be particularly useful to send V2X messages to an appropriate audience, as information can be sent to the server form a client device for distribution, without the client device requiring specific routing information for other nearby client devices to which the message would ideally be routed.

Retrieving the list of service areas may comprise: establishing, by the client device, a communication session between the client device and a server associated with a predetermined service area; sending a subscription, by the client device to a message broker hosted by the server associated with the predetermined service area, to subscribe to a publication comprising the list of service areas; and receiving, by the client device from the message broker hosted by the server associated with the predetermined service area, the publication comprising the list of service areas. In other words, the client device may, via the publish/subscribe protocol, subscribe to publications with a topic related to the list of service areas, and then the server may publish the list of service areas under an appropriate topic so that it is received by the subscribing client devices. The list of service areas may be published with a retain flag ON. This means that the message is memorised by or persists in the messages broker, and the broker delivers the list of service areas to any client device which subscribes to the ‘Service Areas List’ subscription topic. Use of the retain mechanism avoids the necessity to publish the list of service areas periodically.

The method may further comprise storing the list of service areas in internal memory of the client device, for retrieval by a client device at a later time (for instance, when the client device determines it has moved to a new location). Accordingly, in the alternative, retrieving the list of service areas may comprise retrieving the list of service areas from an internal memory of the client device.

The method may further comprise sending one or more subscriptions, by the client device to a message broker at the server associated with the identified service area, to subscribe to a respective one or more publications associated with the identified service area and/or to a respective one or more publications relevant to the geographical location of the client device. In other words, the client device may subscribe to receive publications having a topic relevant to the whole service area (such as a publication of a list of MEC services available within a particular service area). Alternatively or additionally, the client device may subscribe to receive publications related to the particular geographical location of the client device (such as transportation information for a moving client device). In practice, each of the one or more subscriptions may have a different subscription topic, so that each of the one or more subscriptions subscribes to a different one of the one or more publications. The client device may include a geohash of its geographical location as part of the topic of a subscription, in order to subscribe to publications having a particular geohash (or a higher level of the same geohash) as their topic and related to the location denoted by that geohash. In this way, the method provides an effective and efficient method for sending local information (such as traffic information) to a client device.

One of the one or more publications associated with the identified service area may comprise a publication providing a list of services available from the server associated with the identified service area once a communication session has been established. The list of services provided by the server associated with the identified service area to a client device connected to the server may be stored and maintained at the server. Each server may maintain a list of services available to be provided to connected client devices.

Each of the one or more publications relevant to the geographical location of the client device may comprise a publication providing public service information relevant to the geographical location of the client device; or a publication providing transportation system information relevant to the geographical location of the client device. The client device may subscribe to topics including at least a portion of a geohash representing its own geographical location. Publications may include in their topic at least a portion of a geohash representing a location to which the information in the publication is relevant. Where the geohash of a subscription matches the geohash of the publication, the publication will be sent to the client device. In some cases, the geohash length will be different in the publication compared to the subscription, in which case at least the characters in the topic having a shorter geohash should match the initial characters of the geohash in the other topic. Accordingly, the present invention offers a powerful method of distributing location-based information to the client device. In one example, location-based information comprises transportation information or public safety information.

The method may further comprise sending a publication, by the client device to a message broker at the server associated with the identified service area, to publish data obtained by the client device, wherein the data is associated with the geographical location of the client device. For instance, a publication from the client device may relate to road safety or traffic congestion at the location of the client device. Such a publication may be routed by the message broker to other client devices that have subscribed to publications related to locations in the vicinity of the original client device. In this way, the method provides an efficient option for quickly and easily disseminating local information between client devices (V2X messages), or to a control infrastructure to which the information would be useful.

The method may further comprise receiving, by the client device, publications comprising data relevant to a user of the client device at the geographical location. In other words, the client device may receive publications having a topic to which the client device is subscribed. The publication can be published under the given topic by an application server associated with the service area. The topic may include a geohash representing an area including the client device's geographical location.

In a particular example, the publish/subscribe protocol may be a Message Queue Telemetry Transport (MQTT) protocol, and each message broker may be a MQTT broker. MQTT is an established lightweight, publish-subscribe, machine to machine network protocol. MQTT is designed for connections with remote locations that have devices with resource constraints or limited network bandwidth. Therefore, it is useful for efficient routing of data.

Determining of the location may comprise requesting the geographical location of the client device from a Global Navigation Satellite System (GNSS) receiver. In one example, the GNSS receiver could be a GPS receiver. The GNSS receiver may be internal to the client device, or contactable over the cellular network. The client device position may be received from the GNSS receiver as a geohash or a set of coordinates.

The geographical location of the client device may be denoted by a geohash. The location may be provided as a geohash from a GNSS receiver forming part of or connected to the client device, or the geohash may be determined by the client device upon receipt or measurement in another format of a geographical location for the client's device.

The geographical location of the client device may be a first geographical location of the client device, and wherein the identified service area may be a first service area, the method may further comprise, after elapse of a predefined time period, determining, by a client device, a second geographical location of the client device; identifying, by the client device, a second service area relevant to the client device by comparison of the second geographical location of the client device with the list of service areas; and if the second service area is different to the first service area then: determine the distance of the second geographical location of the client device from the perimeter of the first service area; wherein if the distance is greater than a predefined distance threshold then: facilitating or establishing, by the client device, a communication session between the client device and the server associated with the second service area. In other words, the identification of the location of the client device and its associated service area takes place periodically (e.g., after each predefined time period, such as 2 seconds, has elapsed). The client device establishes a communication session with an application server associated with a new service area if the client device is found to be more than a threshold distance inside the perimeter of that new service area. Otherwise, the client device continues to maintain the communication session with the server at the first service. In this way, the client device continues to maintain a communication session with the most relevant service area for its geographical location. The communication session is not handed over from a first service area to a second service area immediately that the client device travels over the border, but instead the method looks to confirm that the client device is well within the new, second service area before handover. This aids continuity of the communication session.

Preferably, the distance to the perimeter of a service area is the distance to the nearest portion of the perimeter from the geographical position of the client device. In other words, the distance is measured as the shortest possible straight-line distance to reach the first service area from the new geographical location of the client device in the second service area.

The geographical location of the client device may be a first geographical location of the client device, and the identified service area may be a first service area, the method may further comprise, after elapse of a predefined time period: determining, by a client device, a second geographical location of the client device; identifying, by the client device, a second service area relevant to the client device by comparison of the second geographical location of the client device with the list of service areas; and if the second service area is different to the first service area then, after elapse of a further one or more of the predefined time period: determining, by a client device, a third geographical location of the client device; identifying, by the client device, a third service area relevant to the client device by comparison of the third geographical location of the client device with the list of service areas; and if the second service area is the same as the third service area, then: facilitating and establishing, by the client device, a communication session between the client device and the server associated with the second service area. In other words, the client device establishes a new communication session after determining that the client device had resided in the new service area for more than a predetermined period of time. As such, establishment of a new communication session is based on time spent in the new service area, rather than on distance from its boundary. Although in this example, a new communication session is established as soon as the client device is determined to be in the new service area for two consecutive time periods, alternatively, there could be a requirement the client device is in the same new service area for three or more consecutive predetermined time intervals.

The method may further comprise sending one or more subscriptions, by the client device to a message broker at the server associated with the second service area, to a respective one or more publications associated with the second service area and/or to a respective one or more publications relevant to the second geographical location of the client device. In other words, the client device my subscribe to publications relevant to its new location (or new service area) in addition to or instead of subscribing to publications related to the first service area (or locations within the first service area).

Prior to establishing the communication session between the client device and the server associated with the second service area the method may further comprise: disconnecting, by the client device, the communication session between the client device and the server associated with the first service area. Some client devices cannot maintain a communication session with a first service area and a second service area simultaneously. In these cases, the client device must disconnect from the communication session with the first service area before establishing a new communication session with the second service area.

Prior to disconnecting the communication session between the client device and the server associated with the first service area, the method may further comprise sending one or more unsubscribe messages, by the client device to a message broker at the server associated with the first service area, to unsubscribe the client device from the respective one or more publications associated with the first service area and/or to one or more publications relevant to the first geographical location of the client device. In other words, to avoid maintaining subscriptions to locations or service areas that are no longer relevant to a client device, the client device can unsubscribe from topics related to the previous location or service area. Unsubscription requests can be sent to the server at a first service area before the communication session with the server at the first service area is disconnected.

The geographical location of the client device may be a first geographical location of the client device, and wherein the identified service area may be a first service area, the method may further comprise, after elapse of a predefined time period: determining, by a client device, a second geographical location of the client device; identifying, by the client device, a second service area relevant to the client device by comparison of the second geographical location of the client device with the list of service areas; and wherein if the second service area is different to the first service area then: facilitating or establishing, by the client device, a communication session between the client device and the server associated with the second service area; or if the second service area is the same as the first service area then: determining, by the client device, a distance of the second geographical location of the client device from a closest portion of a perimeter of the first service area; wherein if the distance is less than a predefined connection threshold, then: identifying, by the client device, an adjoining service area, being the service area contiguously adjoining the closest portion of the perimeter of the first service area, the identifying the adjoining service area by comparison of the second geographical location of the client device with the list of service areas; facilitating or establishing, by the client device, a communication session between the client device and the server associated with the adjoining service area.

Where a client device can maintain a communication session with more than one server (and service area) simultaneously, then the conditions for handover may be different. In particular, the client device may determine it is close to the border with a service area neighbouring the one it is currently connected and, if sufficiently close, may connect to the server at the adjoining service area as well as the service area in which its current location is situated. The client device may then subscribe to and receive publications from both application servers, which may include information relevant to regions either side of the border between the two service areas.

The method may further comprise: determining, by the client device, a distance of the second geographical location of the client device from a closest portion of a perimeter of the second service area; wherein if the distance is more than a predefined disconnection threshold, then: if the first service area is different from the second service area, disconnecting, by the client device, the communication session between the client device and the server associated with the first service area. In other words, once the client device has entered a new service area, it determines whether it has moved sufficiently far from the border between the new, current service area and the previous service area that it should disconnect from any communication session with the previous service area (or whether both connections should be maintained). This determination is made by comparison of the client device's most recent location with a predefined threshold distance (the disconnection threshold) from the boundary between the two service areas (the boundary being the perimeter of the service area in which the client device is situated).

If the second service area is the same as the first service area then the method may further comprise: determining, by the client device, a distance of the second geographical location of the client device from a closest portion of a perimeter of the second service area; wherein if the distance is more than the disconnection threshold, then: disconnecting, by the client device, the communication session between the client device and the server associated with any other service area than the second service area. In other words, if the client device is found to be far enough inside the boundary of the service area in which it resides, any communication session previously established with any other service area may be aborted or disconnected. Whether the client device is sufficiently far inside the boundary may be determined by comparison with the disconnection threshold.

The predefined connection threshold may be different than compared to the predefined disconnection threshold. The predefined connection threshold may be less than the predefined disconnection threshold. Alternatively, the connection threshold may be greater than the disconnection threshold, or the connection threshold and disconnection threshold may be the same. The use of the connection threshold plus the disconnection threshold allows for some ‘hysteresis’ in the connection and disconnection of the client device to the server at the first and second service areas, so that there is no hard boundary for complete handover of the client device from one service area to another. Instead, there is a period in which the client device is connected to both service areas. This increases the continuity for a user of a communication session, as a new session can be established before a previous session is disconnected.

If the second service area is different to the first service area then, after establishing a communication session between the client device and the server associated with the second service area, the method may further comprise: sending one or more subscriptions, by the client device to a message broker at the server associated with the second service area, to a respective one or more publications associated with the second service area and/or to a respective one or more publications relevant to the second geographical location of the client device. If the second service area is the same as the first service area and if the distance is less than a predefined connection threshold then, after establishing the communication session between the client device and the server associated with the adjoining service area, the method may further comprise: sending one or more subscriptions, by the client device to a message broker at the server associated with the adjoining service area, to a respective one or more publications associated with the adjoining service area. In other words, once a communication session has been established with a server at a new service area, the client device may newly subscribe to publications relating to the new service area and/or the most recent location of the client device.

The method may further comprise sending, to the message broker at a server associated with an adjacent service area from the message broker at the server associated with the first service area, one or more publications, wherein the one or more publications are for publication by the message broker at the server associated with the adjacent service area, and wherein the one or more publications are associated with a location within the first service area that is less than a predetermined sharing distance threshold from the adjacent service area; and/or sending, to the message broker at a server associated with the first service area from the message broker at the server associated with the adjacent service area, one or more publications, wherein the one or more publications are for publication by the message broker at the server associated with the first service area, and wherein the one or more publications are associated with a location within the adjacent service area that is less than a predetermined sharing distance threshold from the first service area. The adjacent service area may be the adjoining service area mentioned above. Data or information relevant to an area near to a border of a service area may be shared or replicated at both service areas. In some circumstances, the server at a first service area may share data relevant to a location close to a border with an adjacent service area, the data shared with the server at the adjacent server. The sharing may take place directly between servers at adjacent service areas, in some cases by publication under the publish/subscribe protocol.

Publication by the message broker at the server associated with the adjacent service area may comprise publication by the message broker at the server associated with the adjacent service area to a client device located in, or subscribed to receive publications associated with a geographical region that is within the adjacent service area and less than a predetermined distance from the first service area; and/or publication by the message broker at the server associated with the first service area comprises publication by the message broker at the server associated with the first service area to a client device located in, or subscribed to receive publications associated with, a geographical region that is within the first service area and less than a predetermined distance from the adjacent service area. In other words, once a server receives data shared by the server associated with an adjacent service area, the server may publish that shared information to client devices within a certain distance from the border of the adjacent service area. As noted above, the location-specific publications can be distributed to client devices according to their location by inclusion of an appropriate geohash into the topics of a subscription and publication.

The method may further comprise: obtaining data, by the client device at a geographical location, the data being associated with the geographical location at which it was obtained; identifying, by the client device, a service area relevant to the geographical location at which the data was obtained, by comparison of the geographical location at which the data was obtained with the list of service areas; and sending a publication, by the client device to a message broker at the server associated with the service area relevant to the geographical location at which the data was obtained, the publication containing the data obtained by the client device.

In a second aspect there is a client device for use in a cellular network for providing one or more Multi-access Edge Computing (MEC) services to the client device, the client device comprising at least one processor and at least one memory storing program code instructions, wherein execution of the program code instructions at the processor cause the client device to perform steps according to the method described above. The client device may be configured to carry out any of the steps of the method as described above.

In a third aspect there is a server (for instance, a MEC application server) for use in a cellular network for providing one or more Multi-access Edge Computing (MEC) services to a client device, the server comprising at least one processor and at least one memory storing program code instructions, wherein execution of the program code instructions at the processor cause the server to perform steps according to the method described above.

In a fourth aspect there is a system for providing one or more Multi-access Edge Computing (MEC) services to a client device in a cellular network, comprising: one or more servers, each server associated with a service area and being configured to provide one or more MEC services to one or more client devices, each server configured to implement the steps according to the method described above; and one or more client devices, each client device configured to implement the method described above.

The following numbered clauses show illustrative examples:
1. A method for provision of one or more Multi-access Edge Computing (MEC) services to a client device in a cellular network comprising:
retrieving, by a client device, a list of service areas, each service area representing a geographical area, wherein a server is associated with each service area, the server associated with each service area being configured to provide the one or more MEC services to one or more client devices;
determining, by the client device, a geographical location of the client device;
identifying, by the client device, a service area relevant to the client device by comparison of the geographical location of the client device with the list of service areas;
facilitating, by the client device, a communication session between the client device and the server associated with the identified service area, the communication session for provision of the one or more MEC services to the client device by the server associated with the identified service area.
2. The method of clause 1, wherein a one of the one or more MEC services is a message broker to manage publications and subscriptions according to a publish/subscribe protocol, wherein each server associated with a respective service area is configured to host a message broker.
3. The method of clause 2, wherein retrieving the list of service areas comprises:
establishing, by the client device, a communication session between the client device and a server associated with a predetermined service area;
sending a subscription, by the client device to a message broker hosted by the server associated with the predetermined service area, to a publication comprising the list of service areas; and
receiving, by the client device from the message broker hosted by the server associated with the predetermined service area, the publication comprising the list of service areas.
4. The method of clause 2 or clause 3, further comprising:
sending one or more subscriptions, by the client device to a message broker at the server associated with the identified service area, to a respective one or more publications associated with the identified service area and/or to a respective one or more publications relevant to the geographical location of the client device.
5. The method of clause 4, wherein a one of the one or more publications associated with the identified service area comprises a publication providing a list of services available from the server associated with the identified service area once a communication session has been established.
6. The method of clause 4 or clause 5, wherein each of the one or more publications relevant to the geographical location of the client device comprises:
a publication providing public service information relevant to the geographical location of the client device; or
a publication providing transportation system information relevant to the geographical location of the client device.
7. The method of any one of clauses 2 to 6, wherein the method further comprises:
sending a publication, by the client device to a message broker at the server associated with the identified service area, to publish data obtained by the client device, wherein the data is relevant to the geographical location of the client device.
8. The method according to any one of clauses 1 to 7, wherein determining of the location comprises:
requesting the geographical location of the client device from a GNSS receiver. 9. The method of any one of clauses 1 to 8, wherein the geographical location of the client device is a first geographical location of the client device, and wherein the identified service area is a first service area, the method further comprising, after elapse of a predefined time period:
determining, by a client device, a second geographical location of the client device;
identifying, by the client device, a second service area relevant to the client device by comparison of the second geographical location of the client device with the list of service areas; and
if the second service area is different to the first service area then:
   determine the distance of the second geographical location of the client device from the perimeter of the first service area;
   wherein if the distance is greater than a predefined distance threshold then:
   establishing, by the client device, a communication session between the client device and the server associated with the second service area.
10. The method of any one of clauses 1 to 8, wherein the geographical location of the client device is a first geographical location of the client device, and wherein the identified service area is a first service area, the method further comprising, after elapse of a predefined time period:
determining, by a client device, a second geographical location of the client device;
identifying, by the client device, a second service area relevant to the client device by comparison of the second geographical location of the client device with the list of service areas; and
if the second service area is different to the first service area then, after elapse of a further one or more of the predefined time period:
   determining, by a client device, a third geographical location of the client device;
   identifying, by the client device, a third service area relevant to the client device by comparison of the third geographical location of the client device with the list of service areas; and
if the second service area is the same as the third service area, then:
   establishing, by the client device, a communication session between the client device and the server associated with the second service area.
11. The method of clause 9 or clause 10, further comprising sending one or more subscriptions, by the client device to a message broker at the server associated with the second service area, to a respective one or more publications associated with the second service area and/or to a respective one or more publications relevant to the second geographical location of the client device.
12. The method of any one of clauses 9 to 11, wherein prior to establishing the communication session between the client device and the server associated with the second service area the method further comprises:
disconnecting, by the client device, the communication session between the client device and the server associated with the first service area.
13. The method of clause 12 when dependent on clause 6, or any one of clauses 7 to 12 when dependent on clause 6, wherein prior to disconnecting the communication session between the client device and the server associated with the first service area the method further comprises:
sending one or more unsubscribe messages, by the client device to a message broker at the server associated with the first service area, to unsubscribe the client device from the respective one or more publications associated with the first service area and/or to one or more publications relevant to the first geographical location of the client device.
14. The method of any one of clauses 1 to 8, wherein the geographical location of the client device is a first geographical location of the client device, and wherein the identified service area is a first service area, the method further comprising, after elapse of a predefined time period:
determining, by a client device, a second geographical location of the client device;
identifying, by the client device, a second service area relevant to the client device by comparison of the second geographical location of the client device with the list of service areas; and
wherein if the second service area is different to the first service area then:
   establishing, by the client device, a communication session between the client device and the server associated with the second service area; or if the second service area is the same as the first service area then:
   determining, by the client device, a distance of the second geographical location of the client device from a closest portion of a perimeter of the first service area,
wherein if the distance is less than a predefined connection threshold, then:
   identifying, by the client device, an adjoining service area, being the service area contiguously adjoining the closest portion of the perimeter of the first service area, the identifying the adjoining service area by comparison of the second geographical location of the client device with the list of service areas;
   establishing, by the client device, a communication session between the client device and the server associated with the adjoining service area.
15. The method of clause 14, wherein if the second service area is different to the first service area then, after establishing a communication session between the client device and the server associated with the adjoining service area, the method further comprises:
determining, by the client device, a distance of the second geographical location of the client device from a closest portion of a perimeter of the first service area;
wherein if the distance is more than a predefined disconnection threshold, then:
   disconnecting, by the client device, the communication session between the client device and the server associated with the first service area.
16. The method of clause 14 or clause 15, wherein the predefined connection threshold is less than the predefined disconnection threshold.
17. The method of any one of clauses 14 to 16, wherein if the second service area is different to the first service area then after establishing a communication session between the client device and the server associated with the second service area the method further comprises:
sending one or more subscriptions, by the client device to a message broker at the server associated with the second service area, to a respective one or more publications associated with the second service area and/or to a respective one or more publications relevant to the second geographical location of the client device.
18. The method of any one of clauses 14 to 17, wherein if the second service area is the same as the first service area and if the distance is less than a predefined connection threshold then, after establishing the communication session between the client device and the server associated with the adjoining service area, the method further comprises:
sending one or more subscriptions, by the client device to a message broker at the server associated with the adjoining service area, to a respective one or more publications associated with the adjoining service area.
19. The method of any one of clauses 14 to 18, further comprising sending, to the message broker at a server associated with the adjoining service area from the message broker at the server associated with the first service area, one or more publications relevant to a location that is within the first service area and less than a predetermined distance from the adjoining service area, for publication by the message broker at the server associated with the adjoining service area;
and/or sending, to the message broker at the server associated with the first service area from the message broker at the server associated with the adjoining service area, one or more publications relevant to a location that is within the adjoining service area and less that a predetermined distance from the adjoining service area, for publication by the message broker at the server associated with the first service area.
20. The method of any one of clauses 9 to 19, wherein the method further comprises:
obtaining data, by the client device at a geographical location, the data being relevant to the geographical location at which it was obtained;
identifying, by the client device, a service area relevant to the geographical location at which the data was obtained, by comparison of the geographical location at which the data was obtained with the list of service areas
sending a publication, by the client device to a message broker at the server associated with the service area relevant to the geographical location at which the data was obtained, the publication containing the data obtained by the client device.
21. A client device for use in a cellular network for providing one or more Multi-access Edge Computing (MEC) services to the client device, the client device comprising at least one processor and at least one memory storing program code instructions, wherein execution of the program code instructions at the processor cause the client device to perform the steps of the method of any one of clauses 1 to 20.
22. A system for providing one or more Multi-access Edge Computing (MEC) services to a client device in a cellular network, comprising:
one or more servers, each server associated with a service area and being configured to provide one or more MEC services to one or more client devices; and
one or more client devices, each client device configured to implement the method of any one of clauses 1 to 20.
23. The system of clause 22, wherein one of the one or more MEC services is a message broker to manage publications and subscriptions according to a publish/subscribe protocol, wherein each server associated with a respective service area is configured to host a message broker.

### BRIEF DESCRIPTION OF THE FIGURES

The disclosure can be put into practice in a number of ways, and preferred embodiments will now be described by way of example only and with reference to the accompanying drawings, in which:

FIG. 1(a) and 1(b) illustrate the division of geographical areas into Service Areas. FIG. 1(a) shows the division of an area of western Europe into service areas served by different MEC application servers, whist FIG. 1(b) shows a magnified portion relating to the southern United Kingdom;

FIG. 2 shows a process flow diagram illustrating the steps of a method for update and distribution of a Service Areas list;

FIG. 3 shows a process flow diagram illustrating the steps of a method for provision of one or more Multi-access Edge Computing (MEC) services to a client device in a cellular network;

FIG. 4A shows a schematic diagram illustrating the handover and sharing of data at a border between a first and a second Service Area, wherein a client device can maintain only one communication session at a time;

FIG. 4B shows a schematic diagram of geohash regions in which data relevant to certain geohash regions is shared or replicated with a server across a border with an adjoining Service Area;

FIG. 5 shows a process flow diagram illustrating the steps of a method for handover at a border between a first and a second Service Area, wherein a client device can maintain only one communication session at a time;

FIG. 6 shows a schematic diagram illustrating the handover and sharing of data at a border between a first and a second Service Area, wherein a client device can maintain multiple communication sessions at a time;

FIG. 7 shows a process flow diagram illustrating the steps of a method for handover at a border between a first and a second Service Area, wherein a client device can maintain multiple communication sessions at a time;

FIG. 8 shows a process flow diagram illustrating the steps of a method for distributing and updating a Service List;

FIG. 9 is a schematic diagram of the various entities within a transportation safety ecosystem;

FIG. 10 is an image of an example user display for a vehicle navigation system on which are shown geohash areas from which transportation data may be received; and

FIG. 11 shows a system for provision of transportation safety and infrastructure information.

In the figures, like parts are denoted by like reference numerals. The figures are not drawn to scale.

### DETAILED DESCRIPTION OF THE SPECIFIC EMBODIMENTS OF THE INVENTION

Multi-access edge computing (MEC) is a network architecture that enables cloud computing facilities (including virtual machines) to be provided by servers at the edge of a cellular network, rather than at the network core. This in turn allows for applications and services to be provided closer to a user device connected to the cellular network, thereby reducing latency (so providing faster response time to users) and reducing network congestion.

A MEC application server is distributed and deployed in the edge cloud. Physically, the MEC edge cloud may be located in the local operator core network, e.g. where a packet data network gateway (PGW) is also deployed. In an example for a specific operator, the MEC edge cloud in certain jurisdictions (such as the UK and DE) is based on the Amazon Web Services-Wavelength (AWS-WL) software stack. In other jurisdictions, it may be different.

The MEC application server may provide a platform for a virtual machine or for other application software. For instance, the MEC application server may provide services to user client devices within a geographically local area. The geographical area to which a particular MEC application server provides services is known as a Service Area. Across a geographical region served by a cellular network, the region may be divided into a number of Service Areas, each associated with a particular MEC application server. Each MEC application server provides a particular set of services to connected client devices. The set of services may vary between different MEC servers.

When a user's client device travels across a geographical region and so between adjoining Service Areas, the client device must disconnect from one MEC application server (associated with a first Service Area) and connect to another MEC application server (associated with a second Service Area). This process is known as handover. Ideally, a client device will not switch between Service Areas unless the client device is to be within a geographical region served by a new Service Area for a prolonged period of time. This avoids unnecessary switching and improves the continuity of a communication session for a given client device.

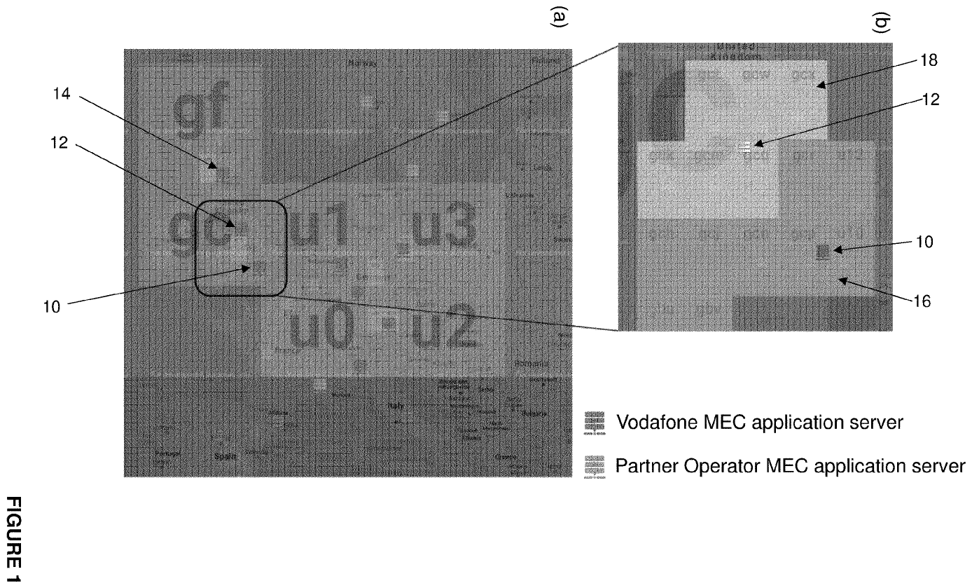

FIG. 1(a) illustrates a distribution of MEC application servers (under the control of different network providers) across a part of Western Europe. It can be seen from FIG. 1(a) that three MEC application servers 10, 12, 14 provide services for client devices across the whole of the UK. FIG. 1(b) shows a magnified portion of the UK region, showing the division of geographical areas into two Service Areas each served by a different MEC application server.

In FIG. 1(a) and 1(b) the allocation of geographical areas is illustrated via use of geohash areas. Geohashes are a simple and effective method of identification of predefined geographical areas. As will be understood by the skilled person, a geohash is an alphanumerical string, which may include (or be specified to) any number of characters, and which provides a unique identifier for a specific region on the surface of the Earth. The geohash is a hierarchical data structure wherein each additional character of the geohash denotes a further subdivision of a larger geographical area. Therefore, a shorter geohash (with fewer characters, or specified to a higher level in a hierarchical structure) represents a larger geographical area than a longer geohash (with more characters or specified to a lower level in the hierarchical structure). As such, each additional character within the geohash may be considered as the geohash being specified to an additional (lower) level of the hierarchical data structure, and to identify a smaller geographical area. Nevertheless, as will be understood by the skilled person, in the method described below the geographical regions allocated to each Service Area may be denoted in other ways (latitude and longitude of borders, for instance).

### Allocation of Service Areas

The division of a geographical region into different Service Areas is recorded in a ‘Service Areas List’. The Service Areas List allocates portions of a geographical region (for instance, with regions denoted by their geohash) to a particular Service Area, wherein each Service Area is associated with a different MEC application server. For instance, in the example shown in FIG. 1(b) the Service Areas List allocates geohash areas gct, gcw, gcx, gck, gem and gcq as being associated within a first Service Area 16 (served by a first MEC application server 10), whereas geohash areas gcr, u12, gch, gcj, gcn, gcp, u10, and gbv would be allocated to a second Service Area 18 (and served by a second MEC application Server 12). The Service Areas 16, 18 are contiguous, without gaps between them.

As user numbers change and the services to be provided by a MEC application server evolve, it may be necessary to add new MEC application servers (or remove existing MEC application servers) and so to reallocate geographical areas between associated Service Areas. The Service Area List would then be updated accordingly. The design and allocation of geographical regions to Service Areas may be coordinated and managed by a Service Areas Manager and the resultant Service Areas List may be saved to a Service Areas Database. Upon a change to the geographical regions allocated a Service Area, a new Service Areas List will be saved to the Service Areas Database and in some cases may also be distributed to each MEC application server associated with the Service Areas for storage locally at each MEC application server.

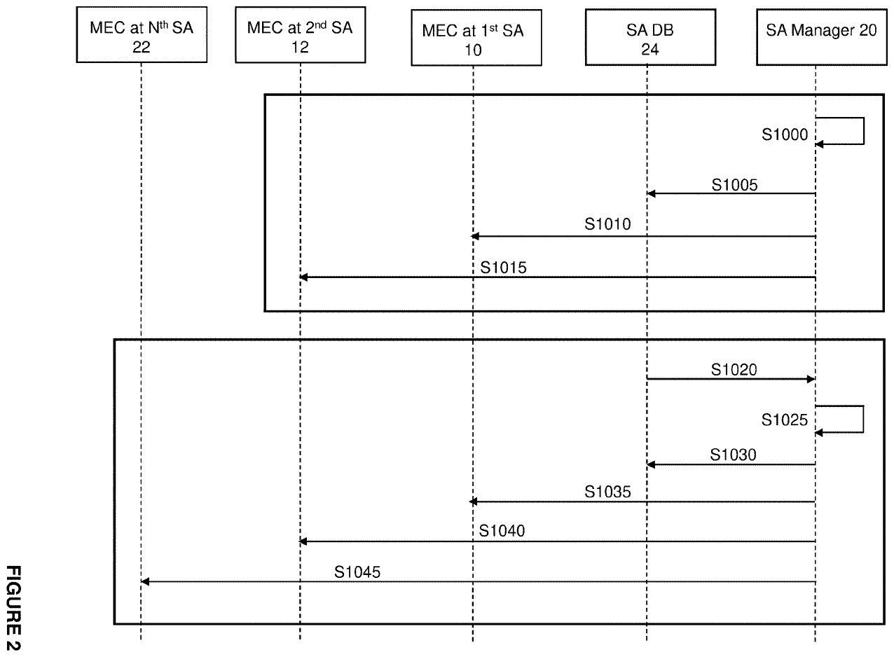

Example steps for updating of the Service Areas List are shown in FIG. 2. The design of Service Areas (being the allocation of geographical regions to a particular Service Area) is arranged by a Service Areas Manager 20. Once allocated, the Service Area Manager 20 prepares (step S1000) the Service Area List to correlate each geographical area (for instance being a series of geohash areas) to a particular Service Area. As noted above, each Service Area is associated with a specific MEC application server. In FIG. 2 a first Service Area is associated with a first MEC application server 10, a second Service Area is associated with a second MEC application server 12, and one or more further Service Areas each associated with a MEC application server.

The Service Area List is sent to a Service Area database 24 for storage (step S1005). The Service Areas List is also sent to each individual Service Area, and more specifically to each MEC application server 10, 12 associated with a Service Area (steps S1010, S1015, where the Service Areas List is sent to the MEC application server at the first Service Area and the MEC application server at the second Service Area). There, the Service Areas List may be stored in memory associated with a given MEC application server 10, 12, for retrieval at a later time.

The Service Area List may be updated, for instance upon introduction of a new Service Area (and associated new MEC application server 22) to provide services to an increased number of users, or to redistribute geographical areas amongst Service Areas. To undertake an update, the existing Service Areas List is retrieved (step S1020) from the Service Area Database 24. The Service Areas Manager 20 may then allocate appropriate geographical areas to the new and/or existing Service Areas. As a consequence, the Service Areas Manager 20 updates (step S1025) the Service Areas List to reflect the new distribution of geographical locations amongst Service Areas.

The updated Service Areas List is then distributed to the Service Areas Database 24 (for storage in memory) (step S1030), and/or to each Service Area (and more specifically the MEC application server 10, 12, 22 at that Service Area, steps S1035, S1040, S1045). The updated list may be stored in memory associated with or in communication with the MEC application server 10, 12, 22 for each Service Area, for retrieval at a later time.

### Optimisation of Routing of Data From the Client Device to the MEC Application Server

The optimal Service Area for a client device at a particular geographical location may be pre-defined. In particular, large geographical regions (such as countries) may be divided into Service Areas according to the previous knowledge and judgement of an operator. However, the routing of data to a MEC application server could also be dynamically adjusted and optimised.

In one example, an iterative process could be used to adjust or optimise Service Areas (each served by an associated application server). In this example, a larger geographical region is initially divided into separate Service Areas by an operator, for instance based on distance to an application server only.

Subsequently, a periodic measurement of the round-trip time for a communication between the client device and different application servers can be measured and recorded by different client devices in the network. In some cases, this could be by sending a ‘ping’ from a client device to one or more different application servers, or by a handshake via the publish/subscribe protocol. Together with its geographical location the measurement of a round trip time by a specific client device may be reported back via a connected application server to a Service Areas Manager.

The Service Areas Manager may aggregate and analyse the measured round-trip time from a plurality of client devices in the network, in order to identify an optimised application server to be connected to a client device for a given geographical location. Based on this analysis, the Service Area Manager may modify the geographical regions allocated to each Service Area, or identify a region requiring implementation of a new Service Area if the quality of service and round trip time is poor.

In view of any modification to the allocated Service Areas, the Service Areas Manager may prepare or update a Service Areas list identifying a Service Area to be associated with a given geographical location. Said list may be distributed or published, for instance upon subscription by a client device, and/or to each MEC application server in an operator network. The updated list can accordingly be retrieved and consulted by a client device, to identify the optimal Service Area with which to establish a communication session, in view of its present geographical location as discussed elsewhere in this disclosure.

Updating or modification of the allocating of Service Areas and the consequent Service Areas List using this process can be periodically repeated, to keep an up-to-date record of optimal data routing dependent on a client's geographical location.

### Connection of a Client Device to a Service Area

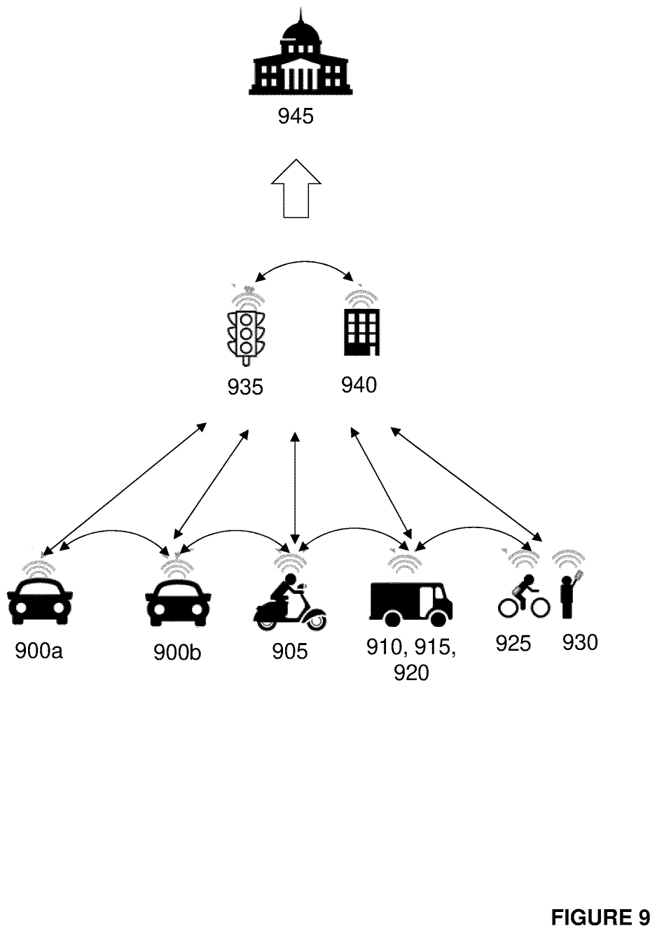

In an aspect of the invention there is a method for provision of one or more Multi-access Edge Computing (MEC) services to a client device in a cellular network. In particular, the method provides steps at the client device to identify and connect to an optimal MEC application server for providing MEC services. One such MEC service may be the provision of a message broker for a publish/subscribe protocol. Examples of other MEC services that could be provided after establishment of a communication session between a client device and a MEC application server include: eGaming (especially outdoor/real-time multiplayer games), eHealth, logistics, drone control and coordination, or control of autonomous operating robots. As will be described in more detail below in relation to FIGS. 9 to 11, in a particular example of a message broker for a publish/subscribe protocol allows delivery of transport information to a client device, wherein that information is targeted to be relevant to the client device in view of its geographical location.

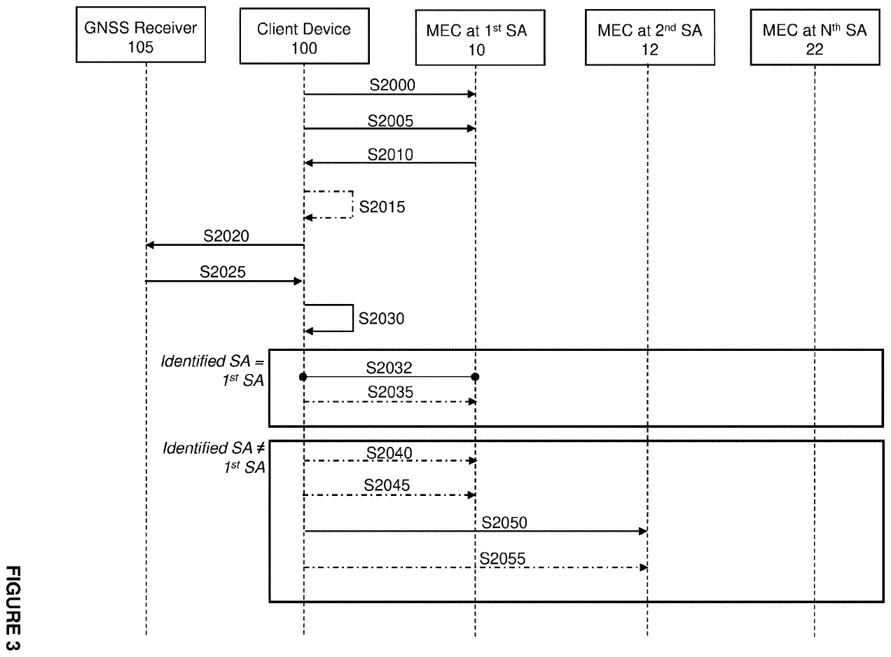

FIG. 3 shows a number of steps forming part of the method, including some optional steps. In a first part, the method comprises retrieving a list of Service Areas (a Service Areas List) at a client device. As described above, each Service Area represents a geographical area. A server (a MEC application server) is associated with each Service Area. The server associated with each Service Area is configured to provide the one or more MEC services to one or more connected client devices. As noted above, the list of Service Areas (Service Areas List) comprises a file in which each geographical area (for instance, represented by geohash areas) is allocated to a particular Service Area associated with a specific MEC application server.

In one example, retrieving a list of Service Areas comprises retrieving, from memory at a client device, a Service Areas list. In another example, retrieving a list of Service Areas comprises connecting to a particular MEC application server associated with a predetermined Service Area, and receiving, at the client device from that MEC application server, a copy of the Service Areas List stored at said MEC application server. In a further alternative example according to FIG. 3, retrieving a list of Service Areas comprises connecting (step S2000) by a client device 100, to a particular MEC application server 10 associated with a predetermined Service Area (the first Service Area in FIG. 3), wherein connecting to the predetermined Service Area comprises establishing a communication session between the client device 100 and the MEC application server 10 associated with the predetermined Service Area.

After the communication session has been established, then the client may subscribe (step S2005) to publications having a topic associated with the Service Area List at a message broker hosted at the MEC application server 10. As a consequence of the subscription, the message broker hosted at the MEC application server 10 publishes (step S2010) the Service Areas List to the client 100. The file may be published after retrieval from memory at the MEC application server, or may be published after receipt from a network database for storage of the Service Area List. Optionally, after the client device 100 has received the Service Areas List, it is stored (step S2015) at internal memory at the client device 100.

In a next part of the method, the client device 100 determines its own geographical location. In one example, the client device 100 determines its own geographical location by requesting (step S2020) the location from a Global Navigation Satellite System (GNSS) receiver 105 (such as a GPS receiver located at the client device 100). The location may be supplied (step S2025) from the GNSS receiver 105 to the client device 100 as a geohash location, or may be supplied as coordinates (longitude and latitude) and then converted by the client device into a geohash.

In a subsequent step, the client device 100 identifies a Service Area relevant to the client device by comparison (step S2030) of the geographical location with the Service Areas List. In particular, the location provided from the GNSS receiver 105 is compared to the Service Areas List to identify the Service Area to which the determined location is allocated. In one example, the comparison comprises comparing a geohash received from the GNSS receiver 105, or generated by the client device 100 from the location received from the GNSS receiver 105, with a geohash within the Service Areas List.

In a final part of the method, the client device 100 facilitates a communication session between the client device and the server associated with the identified Service Area. The communication session is for provision of the one or more MEC services to the client device by the server associated with the identified Service Area. In a first case, the client device 100 concludes that the Service Area to which the determined location is allocated is the same as the predetermined Service Area (to which the client device connected previously in order to retrieve the Service Areas List, and which in the example of FIG. 3 is the first Service Area). In this case, the client device 100 continues to maintain (step S2032) a communication session with that Service Area (and more specifically with the MEC application server 10 associated with that Service Area). In a second case, the client device concludes that the Service Area to which the determined location is allocated is different than the predetermined Service Area (in other words, different to the first Service Area according to the example of FIG. 3). In this case, the client device 100 establishes (step S2050) a communication session between (or connects) the client device 100 and the MEC application server 12 associated with the Service Area allocated to the retrieved location of the client device (which is the second Service Area in the example of FIG. 3).

Optionally in the second case, prior to connecting to any new Service Area, the client device 100 disconnects (step S2045) from (or exits the communication session with) the MEC application server 10 associated with predetermined Service Area. This may be a requirement for certain client devices which are unable to establish and maintain simultaneous communication sessions with more than once Service Area. However, it may also be useful in other cases, in order to allow efficient use of network resources and/or avoid overloading of a processor at the client device.

A final, optional part of the method shown in FIG. 3 comprises steps of subscribing or unsubscribing from publications relating to certain topics, wherein the subscriptions are managed at a message broker hosted at the relevant MEC application server 10, 12. The message broker conforms to a publish/subscribe protocol, for example MQTT. For instance, in the first above case (in which the Service Area to which the determined location is allocated is the same as the predetermined Service Area) then the client may subscribe (step S2035) to a respective one or more publications associated with the identified Service Area and/or to a respective one or more publications relevant to the geographical location of the client device. In the second above case (in which the Service Area to which the determined location is allocated is different than the predetermined Service Area), after a connection session is established (step S2050) with the new Service Area, the client device may further subscribe (step S2055) to a respective one or more publications associated with the identified Service Area and/or to a respective one or more publications relevant to the geographical location of the client device. Where the client device disconnects (step S2045) from the predetermined Service Area before connecting to a new Service Area, then before disconnecting the client device 100 may send a request (step S2040) to the message broker at the MEC application server 10 associated with the predetermined Service Area in order to unsubscribe from publications having a topic associated with the Service Area List. In either case, subscribing (and unsubscribing) comprises sending a subscription (or an unsubscribe request) to a message broker hosted at the relevant MEC application server 10, 12, wherein the subscription (or unsubscribe request) names relevant topics.

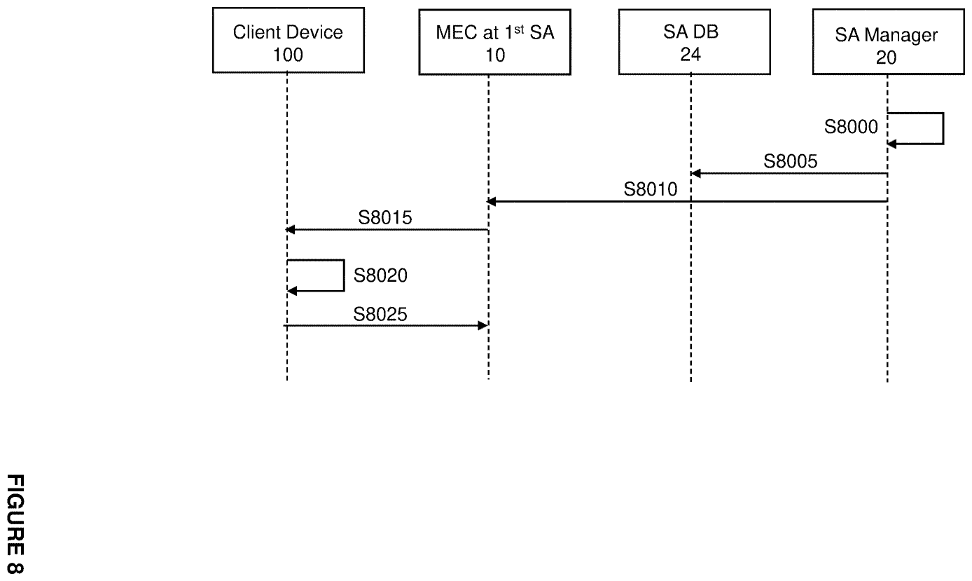

Subscribing (S2035, S2055) to one or more publications associated with the identified Service Area may include subscribing to a publication providing a list of services available from the MEC application server 10, 12 associated with the identified Service Area. For instance, subscribing to these publications allows the client device 100 to receive a list of the services available to be provided by the MEC application server 10, 12. This is described in more detail below with reference to FIG. 8.

Additionally or alternatively, one or more publications relevant to the geographical location of the client device comprises a publication providing public service information (e.g. weather warnings, or other health and safety warnings) relevant to the geographical area associated with the identified service area, or may comprise a publication providing transportation system information (e.g. traffic congestion warnings, or traffic hazards information) relevant to the geographical area associated with the identified service area. In a particular example, the publications may be for V2X message topics, which provide transportation information and hazard warnings for the geographical location local to the client device. This is described in more detail below with reference to FIGS. 9 to 11.

### Connection and Disconnection to a New Service Area

Geographical areas are allocated to Service Areas, as previous discussed. As such, a user may transport a mobile client device from one Service Area to another, meaning that a handover of the client device from connection with a MEC application server at a first Service Area to a MEC application server at a second Service Area may be required. Steps for handover of a device between a first and a second Service Area must be implemented to provide the most efficient data routing for the client device whilst avoiding too frequent switching of connections between Service Areas.

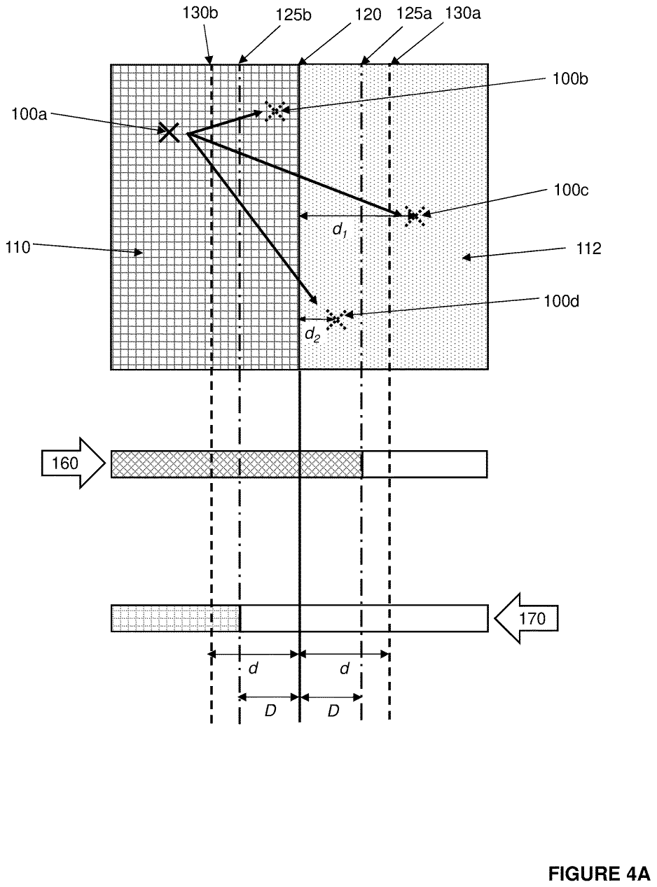

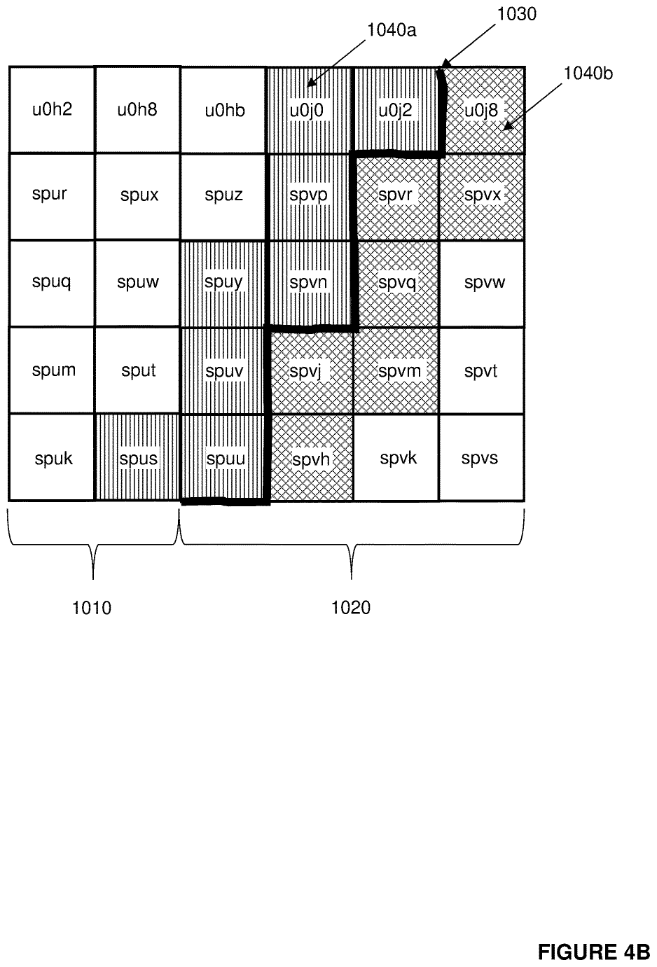

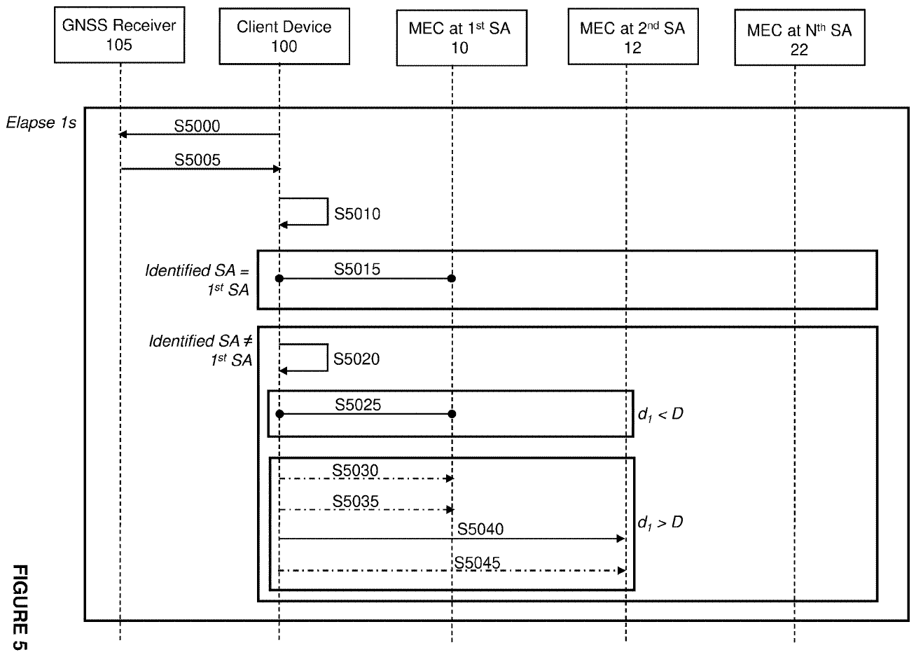

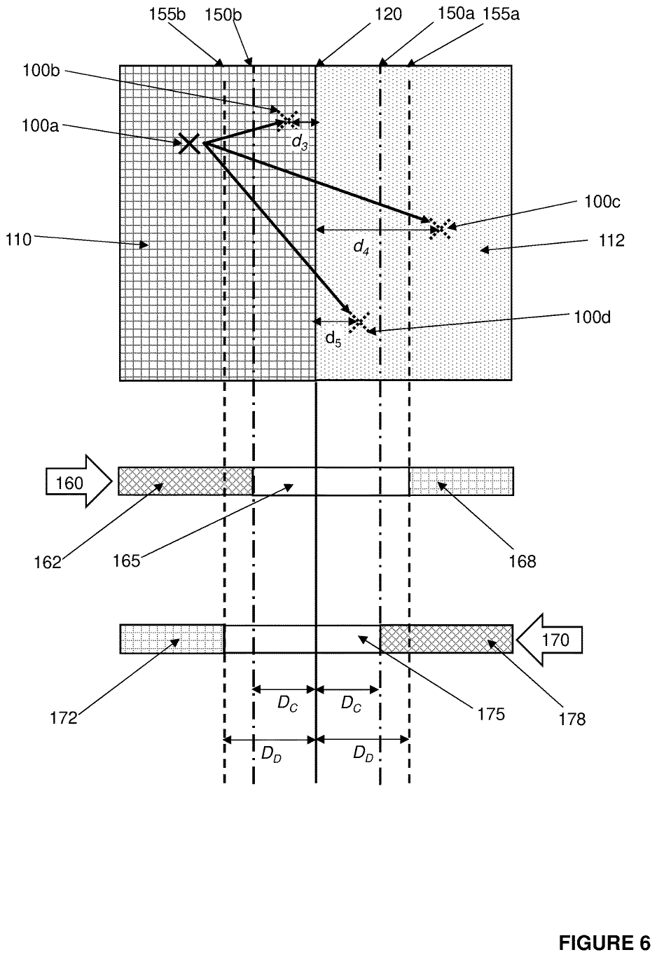

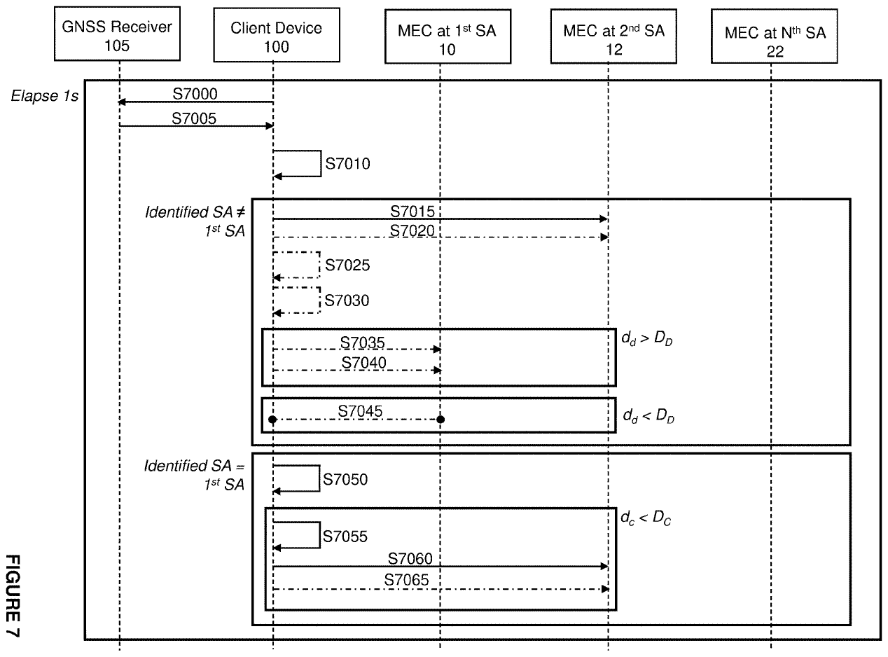

The particular steps for handover between Service Areas will depend on the capability of a client device to connect to one or more communication sessions simultaneously. In a first example, FIGS. 4A and 5 relate to a method for handover between Service Areas for a client device that is capable of connection only to a single communication session at a time. In a second example, FIGS. 6 and 7 relate to a method for handover between Service Areas for a client device that is capable of connection to multiple communication sessions simultaneously.

Referring to FIG. 4A, there is shown a first Service Area 110 adjoining a second Service Area 112. The first and second Service Areas are contiguous, so that there is no gap between them. A client device 100 may move from the geographical area allocated to the first Service Area 110 into the geographical area allocated to the second Service Area 112. Accordingly, for the most efficient data routing the client device 100 may switch from connection to the MEC application server 10 associated with the first Service Area 110 to the MEC application server 12 associated with the second Service Area 112. However, to avoid unnecessary switching between Service Areas (and so continuity of service), it is beneficial for the method to determine that the client device 100 is established (and likely to remain) within the second Service Area 112 before switching takes place. With this in mind, it is not always desirable to switch immediately that the client device 100 crosses the border 120 into a new Service Area.

Steps of a method for handover are show in in FIG. 5. It is assumed that the client device 100 had identified a first geographical location 100a, for instance during connection to a particular Service Area (for instance the first Service Area 110) as discussed above with reference to FIG. 3 (in particular, the steps of FIG. 5 may be considered to follow the steps of FIG. 3). After elapse of a predefined time interval (in the illustrated example, the interval is 1 second), the client device 100 determines a new (i.e., a second) geographical location 100b, 100c or 100d of the client device 100. This represents the geographical location of the client device at the time the new geographical location 100b, 100c or 100d is determined. If the client device is moving, then the second geographical location 100b, 100c or 100d will be different from the original (or first) geographical location 100a. The client device 100 determines its second geographical location by requesting (step 5000) its location from a GNSS receiver 105, and receiving its location in return (step 5005).

Next, by comparison (step S5010) of the new, second geographical location 100b, 100c or 100d with the Service Areas List, the Service Area to which the second geographical location is allocated can be identified. If the Service Area to which the second geographical location 100b, 100c or 100d is allocated is the same as the Service Area to which the first geographical location is allocated, then no handover of Service Area takes place (as the client device is already connected to the MEC application server within the most relevant Service Area, being the Service Area allocated to both the first and the second Service Area). For instance, looking to FIGS. 4A and 5, second geographical location 100b is in the first Service Area 110 (in the same way as the first geographical location 100a), and so no hand over takes place and the communication session between the client device 100 and the MEC application server 10 at the first Service Area 110 is maintained (step S5015).

If, however, the Service Area to which the second geographical location is allocated is different to the Service Area to which the first geographical location is allocated, then alternative steps take place. In particular, if the Service Area to which the second geographical location 100c, 100d is allocated (i.e. a second Service Area 112) is different to the Service Area to which the first geographical location 110a is allocated (i.e. the first Service Area 110), then the client device determines (step S5020) the distance, d₁, of the second geographical location 100c, 100d from the perimeter of the first Service Area (e.g. from boundary 120). In a first scenario, if the distance, d₁, is greater than a predefined distance threshold, D, 125a then the client device undergoes a handover to the Service Area (i.e., second Service Area 112) to which the second geographical location 100c is allocated. As such, the client device 100 establishes (step 5040) a communication session between the client device 100 and the Service Area to which the second geographical location 100c is allocated (i.e., a second Service Area 112). Establishing a communication session with the second Service Area 112 may be considered as the client device 100 connecting to the MEC application server 12 associated with the second Service Area 112. This first scenario would be the case for a client device at second geographical location 100c in FIG. 4A.

In a second scenario, if the client device determines the distance d₂, of the second geographical location from the perimeter of the first Service Area (e.g., boundary 120) is less than the predefined distance threshold, D, 125a then the client device does not undergo a handover to the Service Area to which the second geographical location 100c is allocated. Instead, the client device maintains (step S5025) the communication session with the MEC application server 10 at the first Service Area 110. This second scenario would be the case for a client device at second geographical location 100d in FIG. 4A.

In an alternative example (not shown in FIG. 5), where the Service Area to which the second geographical location is allocated (i.e., a second Service Area 112) is different to the Service Area to which the first geographical location is allocated (i.e. the first Service Area 110), then a different sequence of steps may be implemented. After elapse of a further time period (for instance, after a further 1 second interval), the client determines its geographical location once again. This provides a third geographical location, representative of the location of the client device a certain amount of time after identifying that the client device is within a new Service Area. The client device identifies a Service Area allocated to the third geographical location (i.e., a third Service Area). If the third Service Area is the same as the second Service Area, then the client device establishes a communication session between the client device and the Service Area to which both the second and the third geographical location are commonly allocated. Establishing a communication session with the Service Area to which the second and third geographical locations are commonly allocated may be considered as connecting to the MEC application server associated with the second (and third) Service Area.

Typically, especially when a client device cannot connect to two communication sessions simultaneously, prior to the establishment (step S5040) of the communication session between the client device 10 and the Service Area to which the second geographical location is allocated (the second Service Area 112), the client device disconnects (step S5035) from the communication session between the client device 10 and the Service Area to which the first geographical location is allocated (the first Service Area 112). This step may be beneficial but not essential, depending on the capability of the client device to sustain multiple MEC communication sessions.

After establishing of a new communication session (for instance, between the client device 100 and the MEC application server 12 associated with the second Service Area 112), optionally the client device may subscribe (step S5045) to publications relating to certain topics, wherein the subscriptions are managed at a message broker hosted at the MEC application server 12 of the second Service Area 112. Subscribing may include sending one or more subscriptions to a respective one or more publications associated with the second Service Area, and/or to a respective one or more publications relevant to the new geographical location of the client device. For instance, the client device may subscribe to topics related to a list of services provided at the second Service Area, or to transportation information relevant to the geographical area associated with the second Service Area.

Similarly, before disconnection (step S5035) of a communication session between the client device 100 and the first Service Area 110, the client device may unsubscribe (step S5030) from any publications (i.e., any topics) associated with the first Service Area. This may be implemented by sending one or more unsubscribe requests to the message broker hosted at the MEC application server 10 at the first Service Area 110, wherein the unsubscribe requests relate to topics that are relevant to the first Service Area.

As illustrated at FIG. 4A, the described steps for handover mean that the client device is located well within a new Service Area before handover of a MEC communication session to the MEC application server at the new Service Area. In the event that a client device is travelling close to the border 120 between the two Service Areas 110, 112, communication sessions will not be continually established and disconnected. Instead, handover takes place only once the client device is some distance into a new Service Area. The threshold 125a, 125b for implementing a handover is spaced apart from the boundary between the two Service Areas 110, 112. As such, the particular geographical position at which handover takes place is dependent on the direction of travel of the client device (being a distance, D, from the actual border or boundary 120 between two Service Areas 110, 112). For instance, client device 160, traveling from the first Service Area 110 into the second Service Area 112 will handover at threshold 125a, whereas a client device 170, traveling from the second Service Area 112 into the first Service Area 110 will hand over at threshold 125b.

In some cases, the client device may travel close to the border 120 between two different Service Areas 110, 112 without crossing into a new Service Area. Nevertheless, in this first scenario the user of the client deice may benefit from receiving information, data or services from the application server associated with the adjoining service area. Moreover, in a second scenario certain data distributed by an application server associated with a Service Area may be relevant only to client devices in a portion or sub-region of the Service Area, the portion or sub-region being smaller than the whole Service Area. For instance, it may be useful to distribute transport congestion information at a certain location within a Service Area to a client device at that specific location, but not to every client device within the Service Area. To allow for both these scenarios, data to be published to client devices may be labelled or associated with a particular geographical region or area. Where that particular geographical region or area is at the edge of a Service Area or close to a border between two Service Areas, it may be useful to share that data with client devices in adjoining Service Area over the border.

In a particular example, data or publications are labelled or associated with a geohash. As described elsewhere, a geohash is a hierarchical data structure which denotes a geographical area or region by a string of characters or numbers. The length of the string (e.g., number of characters) is dependent on the size of the area the geohash represents (wherein a shorter geohash represents a larger geographical area, and a longer geohash represents a smaller geographical area).

In one example, a region within a predetermined threshold distance extending from a border of a first Service Area may be predetermined. Data that is labelled or associated with a geohash in this region may be copied or replicated to a server at an adjoining Service Area. In this way, a client device in the adjoining Service Area (and maintaining a communication session only with the server at that adjoining Service Area) may still receive a publication associated with or labelled with a geohash that represents a location in a border area of the first Service Area, as said data may be provided by the server at the first Service Area to the server at the adjoining Service Area.

Boundaries 130a, 130b of a region in which data replication takes place are shown in FIG. 4A. In one example, a first 110 and a second 112 adjoining Service Area share data between them that is labelled or associated with a geohash that denotes an area that is within a predefined distance, d, of the border. In a particular example, d=2 km.

In some cases, the boundary of the region in which data is shared or replicated may defined by a series of geohash regions. As these are polygonal, the boundary will not necessarily represent an exact fixed distance from the boundary between two Service Areas. Nevertheless, data associate with geohash regions bounding the border between two service areas can be shared. FIG. 4B shows geohash regions for sharing data either side of a boundary 1030 between a first 1010 and second 1012 Service Area. Data or publications associated with geohash regions 1040a of the first service area close to the border 1030 will be shared with the server associated with the second Service Area 1020. Data or publications associated with geohash regions 1040b of the second service area close to the border 1030 will be shared with the server associated with the first Service Area 1010. In this way, a client that is able to maintain only a communication session with the Service Area in which that are situated may still benefit from receiving publications relevant to border areas of adjoin service areas.

This system of sharing or replication data associated with a location within a predetermined distance from a border between Service Areas may be particularly useful for distribution of transportation information to client devices, as described below with respect to FIGS. 9 to 11. In particular, transportation data may be distributed via a publish/subscribe protocol, in which the topic of the subscription or publication incorporates a subscription geohash. A geohash is a string of alphanumerical characters that can identify a location to potentially limitless precision (dependent on the length of the geohash). The subscription geohash used within the subscription name is computed by the client device to represent an area in which the geographical location relevant to the client device is situated. The subscription geohash may be computed at the client device using various publically available libraries.

Under a system which includes a subscription geohash within the topic for a publish/subscribe protocol, data to be replicated at a border between Service Areas can be easily identified. In particular, where a server associated with a first Service Area 110 sends to devices within its own Service Area a publication having a geohash within its topic that relates to a geographical location within a predetermined distance or boundary 130b of the border 120 with a second, adjoining Service Area 112, then the MEC application server of the first Service Area 110 also shares the publication with, or copies the publication to, the MEC application server at the second, adjoining Service Area 112. The MEC application server at the second, adjoining Service Area 112 can then distribute or republish the publication to any connected client devices to which the publication would be relevant (in view of the geographical location of the client device).

FIGS. 6 and 7 show an alternative process for handover between Service Areas, for implementation at a client device capable of connection to multiple communication sessions simultaneously. Referring to FIG. 6, there is illustrated a first Service Area 110 adjoining a second Service Area 112. The first and second Service Areas are contiguous, so that there is no gap there between. A client device 100 may move from the geographical area allocated to the first Service Area 110 into the geographical area allocated to the second Service Area 112. Accordingly, data routing to a MEC application server should optimally switch from the MEC application server 10 associated with the first Service Area 110 to the MEC application server 12 associated with the second Service Area 112. However, when the client device is in a region close to the border or boundary 120 between the two Service Areas 110, 112, it may be useful for the client device to be connected to both Service Areas 110, 112 simultaneously.

Steps for handover are shown in FIG. 7. It is assumed that the client device is already connected to a MEC application server 10 associated with a first Service Area 110 after determination of a first geographical location 110a for the client device 110 (following the steps detailed above with respect to FIG. 3). After elapse of a predefined time period (such as 1 second), the client device 100 once again determines its geographical location (considered a second geographical location 100b, 100c or 100d). Determining the second geographical location 100b, 100c or 100d comprises the client device requesting (step S7000) its location from GNSS receiver 105, and receiving (step S7005) a location from the GNSS receiver. The client device then identifies (step S7010) the Service Area associated with the second geographical location 100b, 100c or 100d, by comparison of the geographical location with the Service Areas List.

In a case where the Service Area associated with the second geographical location 100c or 100d is different from the Service Area associated with the earlier, first geographical location 100a (the first Service Area 110, to which the client device is currently connected), then the client device 100 proceeds to establish (step S7015) a communication session between the client device and the second Service Area 112. As before, establishing a communication session comprises connecting the client device to the MEC application server 12 associated with the second Service Area 112.

In the alternative case where the Service Area associated with the second geographical location 100b is the same as the Service Area associated with the earlier, first geographical location 100a (the first Service Area 110), then the client device determines (step S7050) the distance, d_{c}, of the second geographical location from the closest portion of the perimeter of the first Service Area 110 (for the second geographical location 100b, this would be distance d₃ in FIG. 6). The client device subsequently compares that distance, d_{c}, to a predefined connection threshold, D_{c}. If that distance, d_{c}, is less than the predefined connection threshold, D_{c}, (in other words, if the second geographical location 100b of the client device is sufficiently close to the border 120 of the first Service Area 110 with an adjoining Service Area 112 so that, in FIG. 6, d₃<D_{c}) then the client device proceeds to identify (step S7055) that adjoining Service Area (from the Service Area List). Here, the adjoining Service Area is considered to be the Service Area continuously adjoining the closest portion of the perimeter of the first Service Area to the second geographical location (and so the adjoining Service Area would be the second Service Area 112 in relation to second geographical location 100b In FIG. 6). Subsequently, the client device proceeds to establish (step S7060) a communication session between the client device 100 and the adjoining Service Area 112. Establishing a communication session comprises initiating a connection between the client device and the MEC application server 12 associated with the adjoining Service Area 112.

Although, under this scheme, multiple connections to MEC application servers in different Service Areas are envisaged, nevertheless it is beneficial to disconnect from Service Areas that will no longer be relevant to a client device, to avoid overloading the network or the client device. For instance, if the client device has moved out of a first Service Area and into a new, second Service Area and the client device is sufficiently distant from the border between the first and second Service Areas, then it is useful for the client device to disconnect from the communication session with the first Service Area.

FIG. 7 shows a number of optional, additional steps for disconnecting from a Service Area. In one example, where the Service Area associated with the second geographical location 100c, 100d (the second Service Area 112) is different from the Service Area associated with the earlier, first geographical location 110a (the first Service Area 110), after connection of the client device to the new, second Service Area the client device determines (step S7025) a distance, d_{D}, of the second geographical location 100c, 100d from the border between the second Service Area 112 and first Service Area 110. Subsequently, the distance d_{D} is compared (step S7030) to a predefined disconnection threshold, D_{D}. If the distance, d_{D}, is greater than the predefined disconnection threshold, D_{D}, (as would be the case for second geographical position 100c and distance d₄ in FIG. 6) then the client device terminates (step S7040) the communication session between the client device 100 and the MEC application server 10 associated with the first Service Area 110. In other words, the client disconnects from the first Service Area 110. However, if the distance, d_{D}, is less than the predefined disconnection threshold, D_{D}, (as would be the case for second geographical position 100d and distance d₅ in FIG. 6) then the client device maintains (step S7045) a communication session with both the MEC application server 12 at the second Service Area 112 and the MEC application server 10 at the first Service Area 110. Alternatively or additionally (and not illustrated in FIG. 7), periodically the client device may obtain a measure of the distance between its most recent geographical location and the border between the present Service Area of the client device and a Service Area to which an earlier communication session continues to be maintained by the client device. Where that distance is greater than the predefined disconnection threshold, D_{D}, the earlier communication session to the previous Service Area is terminated. In other words, the client device disconnects from the MEC application server associated with the previous Service Area when that Service Are is no longer relevant to the client device.

In any of the examples described above, after establishing (step S7015, S7060) a communication session with a new or an adjoining Service Area, then the client device may optionally subscribe (step S7020, S7065) to publications associated with the respective Service Area. Similarly, prior to the termination (step S7040) of a communication session between the client device and the first or a previous Service Area, the client device may unsubscribe (step S7035) from publications associated with the first or previous Service Area. Subscribing (or unsubscribing) can be realised by sending a subscribe (or unsubscribe) request to a message broker hosted at the given MEC application server, the request specifying given topics.

Looking again to FIG. 6, the predefined connection threshold 150a, 150b (separated from the boundary 120 between Service Areas by distance D_{C}) and predefined disconnection threshold 155a, 155b (separated from the boundary 120 between Service Areas by distance D_{D}) is shown compared to the border 120 between the first Service Area 110 and the second Service Area 112. It can be seen that the connection threshold, D_{C} 150a, 150b (at which a client device connects to an adjoining Service Area 112) is less than the disconnection threshold D_{D} 155a, 155b (at which a client device disconnects from the previous Service Area 110). As such, for a client device 160 travelling from a first Service Area 110 into a second Service Area 112 there is a first region 162 in which the client device is connected to the MEC application server 10 at the first Service Area 110 only, a second region 165 in which the client device 160 maintains a communication session with the MEC application servers 10, 12 associated with the first and second Service Areas 110, 112 simultaneously, and a third region 168 where the client device 160 is disconnected from the communication session with the MEC application server 10 to the first Service Area, and is connected to the MEC application server 12 at the second Service Area 112 only. For a client device 170 moving from a second Service Area 112 to a first Service Area 110, similar regions (i.e. a first region 172 in which the device is connected to the second Service Area only, a second 175 region where the client device is connected to both Service Areas, and a third region 178 where the client device is connected to the first Service Area only) are observed. However, these regions for the two different client device 160, 170 are slightly geographically displaced in comparison to each other. This gives rise to a type of ‘hysteresis’ effect for the handover of client devices dependent on the direction of travel of the client device. As a consequence, the described method increases the likelihood that the client device will be connected to most relevant Service Area, and so will receive relevant information and continuity of service.

### Discovery of Services Provided by a Service Area

Once a client device has established a communication session with a new Service Area, it is necessary for the client device to identify the services available to it within said communication session. The services available are dependent on the services provided by the MEC application server associated with the given Service Area. FIG. 8 shows steps for an example mechanism by which a list of available services can be provided.

In FIG. 8, a publish/subscribe protocol can be used to distribute a Services List. For instance, in a first step a Service Areas Manager 20 can create a Services List, listing the services that can be provided by a particular MEC application server 10, 12. The Services List may also be a compilation of lists, each listing the services available at a different one of the possible MEC application servers 10, 12. After creating the Services List, the Service Areas Manager 20 may store the Services List at a Service Area Database 24. The Service Area Manager 24 may further publish the Services List via a message broker (such as a MQTT broker). The Services List may be published to any device that has subscribed to a particular predefined topic (such as a Service List topic).

For instance in FIG. 8 the Service Areas Manager 24 compiles (step S8000) a Services List comprising services available at a MEC application server 10 associated with a first Service Area 110. The Services List is stored (step S8005) at the Service Area Database 24. The Service Areas Manager 24 further publishes (step S8010) said list to the message broker at the MEC application server 10 associated with the first Service Area 110. The message broker then publishes (step S8015) the Services List to any device 100 or entity which has subscribed to a topic associated with the Services List for the first Service Area. The Services List can then be saved (step S8020) in internal memory at the client device 100. Upon receipt of the Services List, the client device may connect or subscribe (step S8025) to one or more services on the Services List.

The described method allows for straightforward dissemination of changes to available services at a given MEC application server. For instance, by repeating the steps shown in FIG. 8, upon addition of a new service at a particular MEC application server the Service Area Manager can update the Services List in relation to the given Service Area, and then publish the updated Service Area List to any client device subscribed to the relevant Service List topic.

### Provision of Transportation Data Using the Described System and Method

Safe and smooth flow of vehicles in transportation systems can be improved by effective and efficient exchange of data between users, infrastructure providers and transport authorities. Distribution of data relating to local traffic conditions, hazards or weather can allow vehicles to improve safety, avoid congestion, and even reduce energy consumption. However, at present, data obtained and recorded by different entities is fragmented, so that information is not quickly and freely exchanged. For instance, different entities use different connection protocols and services so that, although data may be shared from one user to a particular service provider, it is not easily shared with other nearby vehicles connected to a different service or to a different provider. In one known example, a vehicle may transmit information on local road conditions to a particular vehicle manufacture's systems, but then the data is not quickly and easily distributed across the road network to other vehicle users where the users are connected to a different vehicle manufacture's systems.

A proposed mechanism for distribution of transportation data is vehicle-to-everything (V2X) communication, including vehicle-to-infrastructure, vehicle-to-network, vehicle-to-vehicle, vehicle to pedestrian and vehicle-to-device communications. The earliest implementations of V2X communications relied on dedicated short range radio technologies (Dedicated Short-Range Communications, DSRC), and more recently V2X using cellular networks (relying on Long-Term-Evolution (LTE) or 5G technologies). However, such communications still rely on the introduction of dedicated hardware for setting up of channels between vehicles, devices or other entities, or need communications to be directed to specific recipients. Such requirements can be a barrier to wide-scale implementation and scalability. Instead, V2X communications could be provided via MEC. This allows provision of transportation information using Internet Protocol (IP) based (or over-the-top (OTT)) services, which can be more easily implemented at a user client device without dedicated hardware.

FIG. 9 shows an example of the road transport ecosystem to which V2X communications via MEC may be applied. Ideally, information on traffic hazards, congestion or other traffic concerns would be freely shared between all road users: between cars 900a, 900b, motorcycles 905, trucks 910, buses 915 and trams 920, as well as vulnerable road users (cyclists 925, pedestrians 930). Data may be shared between mobile connected devices embedded within vehicles, or between mobile devices (such as a smartphone) carried by a user. Furthermore, data will be exchanged between road users and road infrastructure 935 (signalling systems, ‘smart’ motorway signalling, variable speed limit systems etc.), as well as with road or transport authorities or emergency services 940. Data obtained and recorded by each of these entities may also usefully be shared with governments and planning authorities 945, in order to inform transport policy and planning. One project looking to fulfil these goals is the Safer Transport for Europe Platform (STEP).

STEP can be implemented by sharing of transportation information using the publish/subscribe protocol, employing a message broker at each MEC application server. Using this protocol, client devices can subscribe to transportation information related to their local area, wherein a message broker at a MEC application server associated with a Service Area to which a client device is connected can publish publications with appropriate topics, or receive publications from the client device. Publications from the client device can be published directly to other local client devices, as well as to central infrastructure (such as road authorities and municipal transport authorities).

In one example, a client device may obtain transport information (for instance, in relation to traffic congestion at a specific geographical location). Making use of publish/subscribe protocol implemented via MEC application servers, this information can easily be disseminated to other road users and to transport authorities, simply by publication of the information by the client device under a topic related to the given geographical location. In this way, direct vehicle-to-vehicle information exchange can be established using services widely available over MEC.

An example of location-based publication of information (for instance, for publication and receipt of transport information relevant to the particular location of a client device) can be found in European Patent Publication No. 3982648 (which is hereby incorporated by reference). This publication describes a system in which a client subscribes (under a publish/subscribe protocol) to a subscription having a subscription name comprising a subscription geohash. The subscription geohash is determined by so as to identify an area including the geographical location relevant to the client device (which may be a present or expected future geographical location of the client device).

In particular, the subscription sent by the client device includes a subscription name, which identifies the class or topic for the subscription. The subscription name comprises a geohash, known as the subscription geohash. The geohash is a string of alphanumerical characters that can identify a location to potentially limitless precision (dependent on the length of the geohash). The subscription geohash used within the subscription name is computed by the client device to represent an area in which the geographical location relevant to the client device is situated. The subscription geohash may be computed at the client device using various publically available libraries.

The subscription geohash is a hierarchical data structure specified to a subscription level. As will be understood by the skilled person, the geohash is an alphanumerical string, which may include (or be specified to) any number of characters. Each additional character of the geohash denotes a further subdivision of a larger geographical area. Therefore, a shorter geohash (with fewer characters, or specified to a higher level in the hierarchical structure) represents a larger geographical area than a longer geohash string (with more characters, or specified to a lower level in the hierarchical structure). As such, each additional character within the geohash may be considered as the geohash being specified to an additional (lower) level of the hierarchical data structure. The specification level to which a subscription geohash is specified denotes the total number of characters within the subscription geohash.

In some cases, the size of the geohash area to which a client device subscribes is determined by the speed of the device. In other words, the level to which the geohash is specified (and so the precision to which the geographical location relevant to the client device is identified in a subscription name) is related to the speed of the client device. The speed of the client device may be a measured instantaneous speed or an average speed, or may be a parameter received at the device (for example, from a measurement at another element of the system). The specification level may be determined from the speed by way of a predefined relationship. For example, a speed may be determined to be within predetermined ranges, with each range associated with a different specification level. In a particular example, a speed within a range of lower speeds may be associated with a relatively lower subscription level (so have more characters within the geohash and so represent a larger area), compared to a speed within a range of higher speeds which may be associated with a relatively higher subscription level (so have relatively fewer characters within the geohash and represent a larger area). Advantageously, this means that a client device moving at higher speed (and so travelling a greater distance within a certain time) may be subscribed to publications related to a relatively larger area than a client device moving at relatively lower speed (and so travelling a smaller distance within the same amount of time). The subscription geohash within a subscription topic may have a predetermined length, in which case any characters not filled by the subscription geohash (for instance, because the geohash denotes a larger area using a geohash of shorter length) can be filled with a “wildcard” character such as a “+”.

Once a client device is subscribed to a subscription topic including a subscription geohash (for instance, the subscription managed by a message broker at a server of the Service Area in which the client is situated) then the client will receive publications having a topic name including the subscription geohash. In other words, the subscription geohash is used (in the topic name) to address subscriptions to devices relevant to a particular geohash location.

A correspondence between the publication and subscription geohash does not necessarily require that both geohash are identical (although identical publication and subscription geohash would correspond). In particular, the server compares each level (each character) in the two geohash. To the extent that both a publication and subscription geohash are specified at a given level, the character must be the same at the given level in both the publication and subscription geohash for the two geohash to correspond. If one of the publication or subscription geohash is specified to a longer level than the other (in other words, one geohash is longer than the other), then the extra characters specified in the longer geohash are not considered within the comparison.

It will be understood that, as a client device travels through a Service Area (or moves to a new Service Area), the client device may unsubscribe from subscriptions that are no longer relevant to a client devices' new, updated location. Accordingly, the client device may send an unsubscribe manage having a previous subscription geohash in the topic, to request to unsubscribe to subscriptions related to the location associated with a previous subscription geohash.

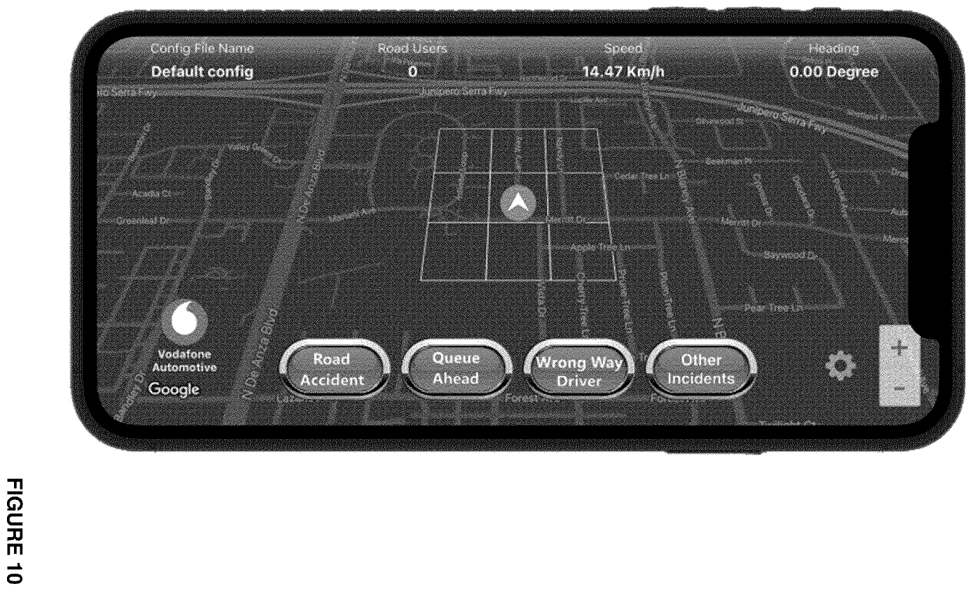

In a particular example, the provision of transportation data relevant to a client device may be implemented by the subscription of a client device to publications related to a first geohash area in which the client device is located, as well as eight further geohash regions surrounding the first geohash area (in particular, located to the nominal north, north-east, east, south-east, south, south-west, west, and north-west of the first geohash area). FIG. 10 shows an image of a vehicle navigation system on which said geohash areas around the client device are shown as polygons. The size of the geohash areas to which subscriptions are sent can be determined or correlated to the speed of movement of the client device, as described above. Periodic determination of the location of the client device allows new subscriptions to be sent as new geohash regions become relevant, and/or for unsubscribe requests to be sent as previous geohash regions cease to be relevant.

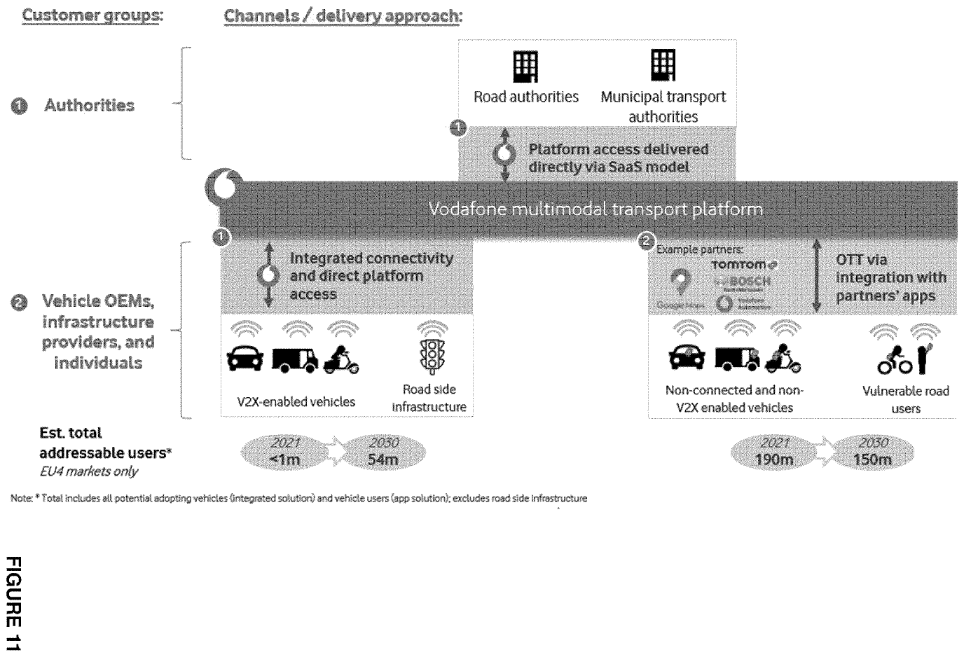

The elements of the transport ecosystem as proposed within STEP are shown in FIG. 11. Advantageously, using the publish/subscribe protocol means that transportation information can easily be exchanged not only with users of a specific telecommunication provider, but all with other partner platforms by integration of MEC services over an IP network (so called over-the-top services).

It will be understood by the skilled person that, although the above examples are described in relation only to a first and a second Service Area (and associated MEC application servers) any number of Service Areas may be provided, each with an associated MEC application server.

A number of combinations of the various described embodiments can be envisaged by the skilled person. All of the features disclosed herein may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” means “one or more”. Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

1. A method for provisioning one or more Multi-access Edge Computing (MEC) services to a client device in a cellular network comprising:
retrieving, by the client device, a list of service areas, each service area of the list of service areas representing a geographical area, wherein a server is associated with each service area of the list of service areas, the server associated with each service area being configured to provide the one or more MEC services to one or more client devices;
determining, by the client device, a geographical location of the client device;
identifying, by the client device, a service area relevant to the client device by comparison of the geographical location of the client device with the list of service areas; and
facilitating, by the client device, a communication session between the client device and the server associated with the service area that was identified, the communication session for provisioning the one or more MEC services to the client device by the server associated with the service area that was identified.

2. The method of claim 1, wherein a one of the one or more MEC services is a message broker to manage publications and subscriptions according to a publish/subscribe protocol, and
wherein each server associated with a respective service area is configured to host a respective message broker.

3. The method of claim 2, wherein retrieving the list of service areas comprises:
establishing, by the client device, a communication session between the client device and a server associated with a predetermined service area;
sending a subscription, by the client device to a message broker hosted by the server associated with the predetermined service area, to subscribe to a publication comprising the list of service areas; and
receiving, by the client device from the message broker hosted by the server associated with the predetermined service area, the publication comprising the list of service areas.

4. The method of claim 2, further comprising:
sending one or more subscriptions, by the client device to a message broker at the server associated with the service area that was identified, to subscribe to a respective one or more publications associated with the service area that was identified and/or to a respective one or more publications relevant to the geographical location of the client device.

5. The method of claim 4, wherein a one of the one or more publications associated with the service area that was identified comprises a publication providing a list of services available from the server associated with the service area that was identified once a communication session has been established; and/or
wherein each of the one or more publications relevant to the geographical location of the client device comprises:
a publication providing public service information relevant to the geographical location of the client device; or
a publication providing transportation system information relevant to the geographical location of the client device.

6. The method of claim 2, wherein the method further comprises:
sending a publication, by the client device to a message broker at the server associated with the service area that was identified, to publish data obtained by the client device,
wherein the data is associated with the geographical location of the client device.

7. The method of claim 1, wherein the geographical location of the client device is a first geographical location of the client device, and wherein the service area that was identified is a first service area, the method further comprising, after elapse of a predefined time period:
determining, by the client device, a second geographical location of the client device;
identifying, by the client device, a second service area relevant to the client device by comparison of the second geographical location of the client device with the list of service areas; and
if the second service area is different to the first service area then:
determine a distance of the second geographical location of the client device from a perimeter of the first service area;
wherein if the distance is greater than a predefined distance threshold then:
facilitating, by the client device, a communication session between the client device and the server associated with the second service area.

8. The method of claim 1, wherein the geographical location of the client device is a first geographical location of the client device, and wherein the service area that was identified is a first service area, the method further comprising, after elapse of a predefined time period:
determining, by a client device, a second geographical location of the client device;
identifying, by the client device, a second service area relevant to the client device by comparison of the second geographical location of the client device with the list of service areas; and
if the second service area is different to the first service area then, after elapse of a further one or more of the predefined time period:
determining, by a client device, a third geographical location of the client device;
identifying, by the client device, a third service area relevant to the client device by comparison of the third geographical location of the client device with the list of service areas; and
if the second service area is the same as the third service area, then:
facilitating, by the client device, a communication session between the client device and the server associated with the second service area.

9. The method of claim 7, wherein prior to establishing the communication session between the client device and the server associated with the second service area the method further comprises:
disconnecting, by the client device, the communication session between the client device and the server associated with the first service area.

10. The method of claim 1, wherein the geographical location of the client device is a first geographical location of the client device, and wherein the service area that was identified is a first service area, the method further comprising, after elapse of a predefined time period:
determining, by a client device, a second geographical location of the client device;
identifying, by the client device, a second service area relevant to the client device by comparison of the second geographical location of the client device with the list of service areas; and
wherein if the second service area is different to the first service area then:
facilitating, by the client device, a communication session between the client device and the server associated with the second service area;
or if the second service area is the same as the first service area then:
determining, by the client device, a first distance of the second geographical location of the client device from a closest portion of a perimeter of the first service area,
wherein if the first distance is less than a predefined connection threshold, then:
identifying, by the client device, an adjoining service area, being the service area contiguously adjoining the closest portion of the perimeter of the first service area, the identifying the adjoining service area by comparison of the second geographical location of the client device with the list of service areas;
facilitating, by the client device, a communication session between the client device and the server associated with the adjoining service area.

11. The method of claim 10, wherein if the second service area is different to the first service area, the method further comprising:
determining, by the client device, a second distance of the second geographical location of the client device from a closest portion of a perimeter of the second service area;
wherein if the second distance is more than a predefined disconnection threshold, then:
disconnecting, by the client device, the communication session between the client device and the server associated with the first service area.

12. The method of claim 11, wherein the predefined connection threshold is less than the predefined disconnection threshold.

13. The method of claim 10, further comprising:
sending, to a message broker at a server associated with an adjacent service area from the message broker at the server associated with the first service area, one or more publications, wherein the one or more publications are for publication by the message broker at the server associated with the adjacent service area, and wherein the one or more publications are associated with a location within the first service area that is less than a predetermined sharing distance threshold from the adjacent service area; and/or
sending, to the message broker at a server associated with the first service area from the message broker at the server associated with the adjacent service area, one or more publications, wherein the one or more publications are for publication by the message broker at the server associated with the first service area, and wherein the one or more publications are associated with a location within the adjacent service area that is less than a predetermined sharing distance threshold from the first service area.

14. The client device for use in the cellular network for providing one or more Multi-access Edge Computing (MEC) services to the client device, the client device comprising at least one processor and at least one memory storing program code instructions, wherein execution of the program code instructions at the processor cause the client device to perform operations of the method of claim 1.

15. A system for providing one or more Multi-access Edge Computing (MEC) services, comprising:
one or more servers, each server associated with a service area and being configured to provide one or more MEC services to one or more client devices; and
one or more client devices, each client device configured to implement the method of claim 1.
